(19) United States
(12) Patent Application Publication
(10) Pub. No.: US 2025/0382543 A1
(43) Pub. Date: Dec. 18, 2025

(54) DETERGANT PARTICLES CONTAINING POLYMER AND SURFACTANT

(71) Applicant: The Procter & Gamble Company, Cincinnati, OH (US)

(72) Inventors: Xin LI, Beijing (CN); Dan XU, Beijing (CN); Gang SI, Newcastle upon Tyne (GB); Rui SHEN, Beijing (CN); Mark Robert SIVIK, Mason, OH (US)

(21) Appl. No.: 19/234,359

(22) Filed: Jun. 11, 2025

(30) Foreign Application Priority Data
Jun. 14, 2024 (WO) PCT/CN2024/099251

(51) Int. Cl. C11D 1/22; C11D 1/12; C11D 1/37; C11D 3/00; C11D 3/37; C11D 17/04

(52) U.S. Cl. CPC C11D 1/22; C11D 1/123; C11D 1/37; C11D 3/3707; C11D 17/044; C11D 3/0036; C11D 2111/12

(57) ABSTRACT

A detergent particle includes a high active linear alkyl benzene sulphonate (LAS) and a polyester soil release polymer. A particulate cleaning composition includes the same. The detergent particle shows good flowability.

### FIELD OF THE INVENTION

The present invention relates to a detergent particle comprising a polyester soil release polymer, and a high active linear alkyl benzene sulphonate (LAS).

### BACKGROUND OF THE INVENTION

As part of the strategy to drive sustainability, the detergent industry has globally engaged in various efforts to drive compaction. Compaction typically means that the product is in a form that uses more active ingredients and less non-active ingredients (such as water, non-active solvents, and fillers). As a result, consumers can reduce the dose of detergent per wash but still achieve the desired wash result. Compaction can further translate to savings in packaging materials, savings in transportation cost, reduced product CO₂ emissions, etc. Active ingredient raw materials available at high active level made from viable industrial process has been a key to enable compaction.

Linear alkylbenzene sulphonate (“LAS”) is one of the most commonly used cleaning actives in detergent formulations. Detergent granules containing LAS can be readily formed by different processes, e.g. agglomeration and spray drying. For example, the liquid acid precursor of LAS, which is the linear alkylbenzene sulphonic acid and is typically referred to as “HLAS,” can be mixed with an aqueous solution of sodium hydroxide (i.e., caustic) to form a substantially neutralized LAS paste, which is then mixed with other powder ingredients to form the detergent granules. Such LAS paste has a relatively high water content, because not only the sodium hydroxide solution introduce water into the mixture, but also the neutralization reaction between HLAS and NaOH generates water as a reaction by-product. Such relatively high water content must be subsequently removed from the detergent granules in order to preserve the free flow characteristic of the dry powder detergents and avoid undesirable “caking” of the finished product. Subsequent water removal is typically achieved by drying, which is an energy and capital-demanding process.

It is desired to provide a high active LAS particle to be used in compact detergent. However, there is a challenge on flowability for detergent granules containing high active LAS. For example, commercially available LAS particles have about 30% active level. There is a continuous need to provide a high active LAS-containing detergent granule, exhibiting desirable flowability. Adding inorganic or organic fillers into LAS particles could be a solution for providing better flowability, but it is always desirable to minimize usage of non-active ingredients.

Polyester soil release polymers are also known and used in fabric and home care formulations. In the washing process, soil release polymers can deposit on fibers, which change the surface properties of fabric and deliver various benefits, such as reduced soil deposition onto fabric during wash and wear; reduced adhesion of microorganism and allergens onto fabric; easier soil removal from fabrics which treated with soil release polymer in previous wash; reduced malodor; improved wicking properties.

The inventors have surprisingly found specific polyester soil release polymers can be incorporated into detergent particles that comprise high level of LAS surfactant. Said polyester soil release polymer surprisingly helps to form a high active LAS-containing particle and provide superior flowability during manufacturing and usage.

### SUMMARY OF THE INVENTION

The present invention employs a polyester soil release polymer to improve and optimize the flowability profile of a granular laundry detergent composition, that contains a relatively high level of anionic surfactant LAS.

In one aspect, the present invention relates to a detergent particle comprising:
from 50% to 95%, by weight of the detergent particle, an alkyl benzene sulphonate anionic surfactant;
from 0.1% to 20%, by weight of the detergent particle, a polyester soil release polymer;
wherein the polyester soil release polymer comprising:
   (a) at least one terephthalate structural unit,
   (b) at least one alkylene glycol structural unit, and
(c) at least one polyalkylene glycol structural unit comprising at least one ethylene glycol moiety.

In some embodiments, the alkyl benzene sulphonate anionic surfactant contained in the detergent particle is a C₁₀-C₂₀ linear alkyl benzene sulphonate. In preferred embodiments, the alkyl benzene sulphonate anionic surfactant is a sodium salt of C₁₀-C₂₀ linear alkyl benzene sulphonate.

In some preferred embodiments, the alkyl benzene sulphonate anionic surfactant is present in an amount of from 60% to 95%, more preferably from 65% to 93%, alternatively from 70% to 90%, or 75% to 90%, by weight of the detergent particle.

In some embodiments, the polyester soil release polymer contained in the detergent particle comprises: at least one terephthalate structural unit (a), at least one alkylene glycol structural unit (b), and at least one polyalkylene glycol structural unit comprising at least one ethylene glycol moiety (c), wherein the molar ratio between (i) ethylene glycol moiety present in the polyalkylene glycol structural unit (c) to (ii) terephthalate moiety present in the terephthalate structural unit (a) is at least 5.0, preferably in the range of from 8 to 25.

In some embodiments, the polyester soil release polymer comprises at least one terephthalate structural unit (a), at least one alkylene glycol structural unit (b), at least one polyalkylene glycol structural unit selected from a first polyalkylene glycol structural unit (c1) and/or a second polyalkylene glycol structural unit (c2), with the structures of (a), (b), (c1) and (c2) as shown below:

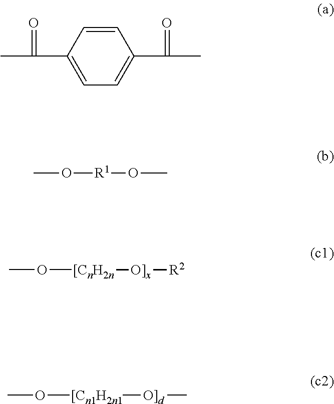

wherein,
   R¹ is a linear or branched alkylene group represented by the formula (CₘH₂ₘ) wherein m is an integer from 2 to 12,
   R² is a linear or branched C₁-C₃₀ alkyl group, a cycloalkyl group with from 5 to 9 carbon atoms or a C₆-C₃₀ arylalkyl group,
   n is independently selected from an integer from 2 to 12,
   x is, based on a molar average, a number from 2 to 200,
   n1 is independently selected from an integer from 2 to 12,
   d is, based on molar average, a number from 2 to 200,
wherein the polyalkylene glycol structural units (c1) and/or (c2) comprises at least one ethylene glycol moiety,
wherein the molar ratio between (i) ethylene glycol moiety present in the polyalkylene glycol structural units (c1) and (c2) to (ii) terephthalate moiety present in the terephthalate structural unit (a) is in the range of from 10 to 20.

In some embodiments, the polyester soil release polymer further comprises additional anionic moiety such as structural unit comprising sulfonate group.

In some embodiment, the polyester soil release polymer further comprise structural units derived from other di-carboxylic acids or their salts or their (di)alkylesters.

In some embodiments, the polyester soil release polymer is a nonionic soil release polymer comprises at least one terephthalate structural unit (a), at least one alkylene glycol structural unit (b), at least one polyalkylene glycol structural unit selected from a first polyalkylene glycol structural unit (c1), and at least one polyalkylene glycol structural unit selected from a second polyalkylene glycol structural unit (c2).

In some embodiments, the detergent particle further comprises from 0.01% to 5%, by weight of the detergent particle, of sodium sulfosuccinate.

In some embodiments, the detergent particle is characterized by: (1) a particle size distribution Dw50 of from 100 μm to 1000 μm; (2) a bulk density of from 400 to 1000 g/L; and (3) a moisture content of from 0 wt % to 8 wt %, preferably from 0 wt % to 3 wt %.

In another aspect, the present invention relates to a cleaning composition in solid form, comprising from 0.1% to 99%, preferably from 5% to 90%, by weight of the composition, of the detergent particle described herein, and from 0.1% to 99%, by weight of the composition, of an additional ingredient, wherein the additional ingredient is selected from the group consisting of perfume, perfume encapsulates, surfactants, polymers, enzymes, bleach, bleach activators, phosphates, zeolite, silicates, carbonates, sodium chloride, chelants, hueing agents, dye transfer inhibitors, and any combinations thereof.

In another aspect, the present invention relates to a method for making the detergent particle described herein.

In another aspect, the present invention relates to a method for using the cleaning composition in solid form, which contains the detergent particles described herein and additional ingredients.

In another aspect, the present invention relates to detergent particles being made in a various forms to include but not limited to granular, regular or irregular spherical, flake, or powder.

In another aspect, the present invention relates to a method for treating laundry with the cleaning composition described herein.

In another aspect, the present invention relates to a water-soluble unit dose article comprising the detergent particle described herein.

An advantage of the present invention is to provide a detergent particle comprising high active LAS and polyester soil release polymers to show good compatibility with the specific making process of the particle.

Another advantage of the present invention is to provide a detergent particle to show good flowability, and good storage stability.

Another advantage of the present invention is to provide a detergent particle showing good cleaning benefit when used in a cleaning composition in solid form.

These and other aspects of the present invention will become more apparent upon reading the following detailed description of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the term “cleaning composition” means a liquid or solid composition, and includes, unless otherwise indicated, granular or powder-form all-purpose or “heavy-duty” washing agents, especially cleaning detergents, for fabrics, as well as cleaning auxiliaries such as bleach, rinse aids, additives, or pre-treat types; hand dishwashing agents or light duty dishwashing agents, especially those of the high-foaming type; machine dishwashing agents; mouthwashes, denture cleaners, car or carpet shampoos, bathroom cleaners; hair shampoos and hair-rinses; shower gels and foam baths and metal cleaners; as well as cleaning auxiliaries such as bleach additives or pre-treat types. In one preferred aspect, the cleaning composition is a solid laundry detergent composition, and more preferably a free-flowing particulate laundry detergent composition (i.e., a granular laundry detergent product).

As used herein, the term “detergent particle” means a solid cleaning composition or a solid detergent composition, preferably a free-flowing particulate detergent composition (i.e., a granular detergent product). In one preferred aspect, the detergent particle is a granular laundry detergent product.

As used herein, the phrases “water-soluble unit dose article,” “water-soluble fibrous structure”, and “water-soluble fibrous element” mean that the unit dose article, fibrous structure, and fibrous element are miscible in water. In other words, the unit dose article, fibrous structure, or fibrous element is capable of forming a homogeneous solution with water at ambient conditions. “Ambient conditions” as used herein means 23° C.±1.0° C. and a relative humidity of 50%±2%. The water-soluble unit dose article may contain insoluble materials, which are dispersible in aqueous wash conditions to a suspension mean particle size that is less than about 20 microns, or less than about 50 microns.

As used herein, the terms “consisting essentially of” means that the composition contains less than about 1%, preferably less than about 0.5%, of ingredients other than those listed.

Further, the terms “essentially free of”, “substantially free of” or “substantially free from” means that the indicated material is present in the amount of from 0 wt % to about 0.5 wt %, or preferably from 0 wt % to about 0.1 wt %, or more preferably from 0 wt % to about 0.01 wt %, and most preferably it is not present at analytically detectable levels. The term “substantially pure” or “essentially pure” means that the indicated material is present in the amount of from about 99.5 wt % to about 100 wt %, preferably from about 99.9 wt % to about 100 wt %, and more preferably from 99.99 wt % to about 100 wt %, and most preferably all other materials are present only as impurities below analytically detectable levels.

As used herein, the term “water-soluble” refers to a solubility of more than about 30 grams per liter (g/L) of deionized water measured at 20° C. and under atmospheric pressure.

As used herein, all concentrations and ratios are on a weight basis unless otherwise specified. All temperatures herein are in degrees Celsius (° C.) unless otherwise indicated. All conditions herein are at 20° C. and under atmospheric pressure, unless otherwise specifically stated. All polymer molecular weights are determined by weight average number molecular weight unless otherwise specifically noted.

### Determent Particle

The detergent particle of the present invention comprises a relatively high amount of alkyl benzene sulphonate anionic surfactant and a polyester soil release polymer.

Preferably, the detergent particle is characterized by: (1) a particle size distribution Dw50 of from 100 μm to 1000 μm, preferably from 150 μm to 800 μm; (2) a bulk density of from 400 to 1000 g/L; and (3) a moisture content of from 0 wt % to 8 wt %, preferably from 0 wt % to 3 wt %. Preferably, the detergent particle is a solid free-flowing particle.

### Alkyl Benzene Sulphonate Anionic Surfactant.

The detergent particle comprises from 50% to 95%, by weight of the detergent particle, an alkyl benzene sulphonate anionic surfactant. Preferably, the alkyl benzene sulphonate anionic surfactant is present in an amount of from 60% to 93%, more preferably from 65% to 90%, alternatively from 70% to 95%, or 75% to 90%, by weight of the detergent particle.

Preferably, the alkyl benzene sulphonate anionic surfactant contained in the detergent particle is a C₁₀-C₂₀ linear alkyl benzene sulphonate (LAS). LAS anionic surfactants are well known in the art and can be readily obtained by sulphonating commercially available linear alkylbenzenes. Suitable LAS is obtainable, preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, although other synthesis routes, such as HF, may also be suitable. In one aspect a magnesium salt of LAS is used.

Suitable LAS may comprise a component obtained from waste plastic feedstock. Preferably LAS obtained from waste plastic feedstock comprises from 0.001 to 100% wt. of the total LAS, more preferably from 0.01 to 50 wt. %, more preferably from 0.1 to 20 wt. %, most preferably from 0.5 to 10%. Suitable LAS obtained from waste plastic feedstock are described for example in WO2023057604, WO2023057531 and WO2023057530.

Exemplary C₁₀-C₂₀ LAS that can be used in the present invention include alkali metal, alkaline earth metal or ammonium salts of C₁₀-C₂₀ linear alkylbenzene sulphonic acids, and preferably the sodium, potassium, magnesium and/or ammonium salts of C₁₁-C₁₈ or C₁₁-C₁₄ linear alkylbenzene sulphonic acids. More preferred are the sodium or potassium salts of C₁₂ linear alkylbenzene sulphonic acids, and most preferred is the sodium salt of C₁₂ linear alkylbenzene sulphonic acid, i.e., sodium dodecylbenzene sulphonate.

Preferably, the LAS is selected from C₁₀-C₁₆ linear alkyl benzene sulfonic acids, alkali metal or amine salts of C₁₀-C₁₆ linear alkyl benzene sulfonic acids, wherein the HLAS surfactant comprises greater than 50% C₁₂, preferably greater than 60%, preferably greater than 70% C₁₂, more preferably greater than 75%.

The detergent particle of the present invention provides the LAS being present at a significantly higher level, e.g., from about 50% to about 95%, preferably from about 60% to about 95%, and more preferably from about 65% to about 93%, alternatively from about 70% to about 90%, or about 75% to about 90%, by weight of the detergent particle. This is achieved by incorporating a polyester soil release polymer, which not only provides active soil release benefit, but also surprisingly helps constituting high-LAS particle with desirable flowability, density and solubility.

### Polyester Soil Release Polymer.

The polyester soil release polymer comprises:
(a) at least one terephthalate structural unit,
(b) at least one alkylene glycol structural unit, and
(c) at least one polyalkylene glycol structural unit comprising at least one ethylene glycol moiety.

Preferably, the polyester soil release polymer comprises at least one terephthalate structural unit (a), at least one alkylene glycol structural unit (b), at least one polyalkylene glycol structural unit selected from a first polyalkylene glycol structural unit (c1) and/or a second polyalkylene glycol structural unit (c2), with the structures of (a), (b), (c1) and (c2) as shown below:

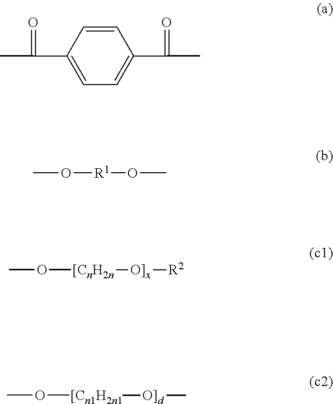

wherein,
   R¹ is a linear or branched alkylene group represented by the formula (CₘH₂ₘ) wherein m is an integer from 2 to 12,
   R² is a linear or branched C₁-C₃₀ alkyl group, a cycloalkyl group with from 5 to 9 carbon atoms or a C₆-C₃₀ arylalkyl group,
   n is independently selected from an integer from 2 to 12,
   x is, based on a molar average, a number from 2 to 200,
   n1 is independently selected from an integer from 2 to 12,
   d is, based on molar average, a number from 2 to 200,
wherein the polyalkylene glycol structural units (c1) and/or (c2) comprises at least one polyethylene glycol moiety,
wherein, polyester soil release polymer has the PEG content from 40% to 90%.

Herein, the PEG content of the polyester soil release polymer is defined as below:

$$PEG content = \frac{Total MW of polyethylene glycol moiety within the polymer}{MW of the polyester} \times 100 \%$$

In some embodiments, PEG content of a polyester soil release polymer can be calculated based on dosage of reactant used to make the polymer. In some embodiment, PEG content can be measured using analytical method, such as NMR.

Preferably, the molar ratio between (i) ethylene glycol moiety present in the polyalkylene glycol structural units (c1) and (c2) to (ii) terephthalate moiety present in the terephthalate structural unit (a) is in the range of from 10 to 20.

Preferably, the alkylene glycol structural unit (b) has a structure such that,
R¹ is a linear or branched alkylene group represented by the formula (CₘH₂ₘ) wherein m is each independent an integer of from 2 or 3.

Preferable, the first polyalkylene glycol structural unit (c1) has a structure such that,
R² is a linear or branched C₁-C₆ alkyl group, preferably methyl group,
n is independently selected from an integer from 2 to 4, preferably 2,
x is, based on a molar average, a number from 4 to 150.

Preferably, the second olyalkylene glycol structural unit (c2) has a structure such that,
n1 is independently selected from an integer of from 2 to 4, preferably 2,
d is, based on a molar average, a number of from 4 to 150.

Preferably, the second polyalkylene glycol structural unit (c2) has a structure:

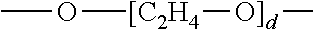

wherein d is, based on a molar average, a number of from 10 to 120.

Preferably, the average total molecular weight of ethylene glycol moiety present in the polyalkylene glycol structural units (c1) and (c2) in the polyester soil release polymer molecule, is from 1000 to 20000.

Typically, Structural unit (a) is derived from terephthalic acid and/or derivatives thereof. The “derivatives thereof” comprises, without limitation, salts, esters, diesters, and/or anhydrides. Preferred ester and diester here include methyl ester, and ethyl ester.

Typically, structural unit (b) is derived from a diol having a structure of HO—R¹—OH, wherein R is defined same as above.

Typically, structural unit (c) is derived from a mono ether of polyalkylene glycol. The mono ether of polyalkylene glycol has a structure of HO—[CₙH₂ₙ—O]ₓ—R², wherein, n, x and R² are defined same as above. Preferably, the mono ether of polyalkylene glycol is selected from poly(ethylene glycol) monoalkyl ethers, such as poly(ethylene glycol) monomethyl ether (mPEG). Suitable mPEG has polyethylene glycol number average molecular weight between 40 and 8000, preferably from 100 to 4000, most preferably from 150 to 2500. mPEG examples are mPEG200, mPEG300, mPEG550, mPEG750, mPEG1000, mPEG1500, mPEG2000, mPEG2500, mPEG3000, mPEG3500, mPEG4000, and mPEG4500.

Typically, structural unit (d) is derived from polyalkylene glycol having a structure of HO—[Cₙ₁H₂ₙ₁—O]_{d}—H, where n1 and d are defined same as above. Preferably, the polyalkylene glycol is selected from polyethylene glycol (PEG) with weight average molecular weight from 100 to 4000, preferably from 150 to 3000, preferably from 200 to 2000, more preferably from 250 to 1000.

Optionally, the polyester soil release polymer further comprises a structural unit (d)

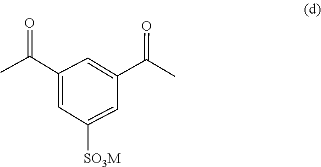

wherein, M is a counterion selected from Na⁺, Li⁺, K⁺, ½ Mg²⁺, ½ Ca²⁺, ⅓ Al³⁺, ammonium, mono-, di-, tri-, or tetraalkylammonium wherein the alkyl groups are C₁-C₁₈ alkyl or C₂-C₁₀ hydroxyalkyl, or mixtures thereof.

Typically, structural unit (d) is derived from 5-sulfoisophthalic acid and/or derivatives thereof. The “derivatives thereof” comprises, without limitation, salts, esters, diesters, and/or anhydrides. Preferred ester and diester here include methyl ester, and ethyl ester.

Optionally, the polyester soil release polymer further comprises one or more anionic terminal unit (e) and/or (f) as described in EP3222647, where M has same definition as in above (d)

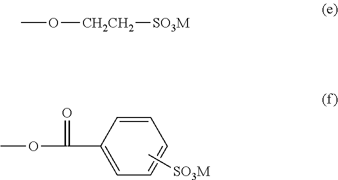

Optionally, the polyester soil release polymer may comprise crosslinking structural unit derived from monomers which comprise at least three functional groups capable of forming esters. Examples of monomers which comprise at least three functional groups capable of forming esters include, but not limit to, trimellitic acid, citric acid, glycerine, sorbitol.

Optionally, the polyester soil release polymer further comprise structural units derived from other di-carboxylic acids or their salts or their (di)alkylesters. Suitable examples include:
(i). Furandicarboxylic acids, such as 2,5-furandicarboxylic acid. If present, the additional monomer 2,5-furandicarboxylic acid forms structural unit (a1) within the polyester soil release polymer.

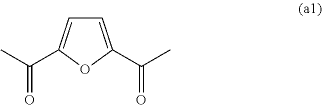

(ii). Pyridine dicarboxylic acids, such as pyridine-2,5-dicarboxylic acid, pyridine-2,6-dicarboxylic acid, pyridine-2,4-dicarboxylic acid, and pyridine-3,5-dicarboxylic acid, pyridine-2,4-dicarboxylic acid, preferably pyridine-2,5-dicarboxylic acid. If present, the additional pyridine dicarboxylate acids form structural unit (a2) to (a6) within the polyester soil release polymer.

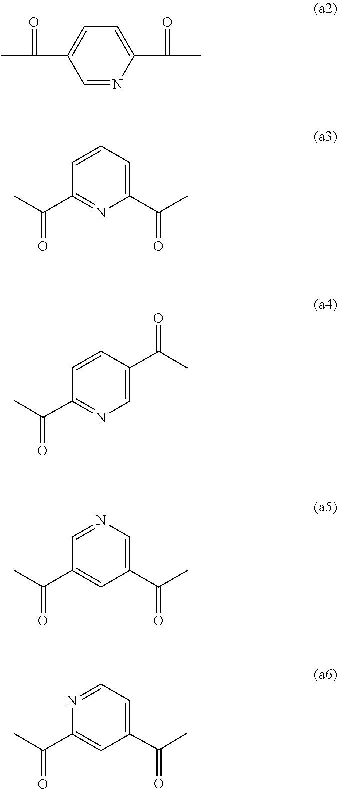

(iii). Cyclohexanedicarboxylic acids, such as 1,4-cyclohexanedicarboxylic acid,
(iv). Other diacids, such as adipic acid, sebacic acid, fumaric acid, maleic, succinic acid, glutaric acid, azelaic acid.

In one embodiment, the polyester soil release polymer comprises at least one terephthalate structural unit (a), at least one alkylene glycol structural unit (b), at least one polyalkylene glycol structural unit selected from a first polyalkylene glycol structural unit (c1), and at least one second polyalkylene glycol structural unit (c2), with the structures of (a), (b), (c1) and (c2) as defined above.
wherein,
   R¹ is a linear or branched alkylene group represented by the formula (CₘH₂ₘ) wherein m is an integer from 2 to 3, preferably 3,
   R² is a linear or branched C₁-C₆ alkyl group, preferably methyl group,
   n is independently selected from an integer from 2 to 3, preferably 2,
   x is, based on a molar average, a number from 4 to 150,
   n1 is independently selected from an integer from 2 to 3, preferably 3,
   d is, based on molar average, a number from 4 to 100,
wherein the polyalkylene glycol structural units (c1) and/or (c2) comprises at least one polyethylene glycol moiety,
wherein the molar ratio between (i) ethylene glycol moiety present in the polyalkylene glycol structural units (c1) and (c2) to (ii) terephthalate moiety present in the terephthalate structural unit (a) is in the range of from 10 to 20.
wherein the PEG content of the polyester soil release polymer is from 50% to 90%.

Preferred polyester soil release polymer of this type has a CAS number: 152442-40-5.

In another embodiment, the polyester soil release polymer has a structure according to formula below:

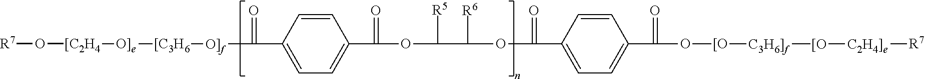

wherein:
R⁵ and R⁶ are independently selected from H or CH₃. Preferably, one of the R⁵ and R⁶ is H, and another one of the of the R⁵ and R⁶ is CH₃.
e, f are, based on molar average, a number independently selected from 0 to 200, where the sum of e+f is from 2 to 400,
More preferably, f is from 0 to 50, e is from 1 to 200,
More preferably, f is 1 to 10, e is 5 to 150,
R⁷ is C₁₋C₄ alkyl and more preferably methyl,
n is, based on molar average, from 1 to 50.

One example of the most preferred above suitable terephthalate-derived nonionic polyester soil release polymer has one of the R₅ and R₆ is H, and another is CH₃; f is 0; e is from 5-100 and R⁷ is methyl, and n is from 3-10.

Other suitable terephthalate-derived polyester soil release polymer is described in patent WO2014019903, WO2014019658 and WO2014019659. The end capping group of these polyester soil release polymers are selected from:

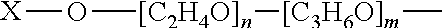

wherein X is C₁-C₄ alkyl and preferably methyl, the —[C₂H₄O] groups and the —[C₃H₆O] groups are arranged blockwise and the block consisting of the —[C₃H₆O] groups is bound to a —CO—Ar—CO— structural unit via an ester bond, n is based on a molar average a number of from 40 to 50, m is based on a molar average a number from 1 to 10 and preferably from 1 to 7.

The polyester soil release polymer may or may not be biodegradable, preferred polyester soil release polymers are readily biodegradable.

Commercially available examples of suitable polyester soil release polymers include TexCare® series supplied by Clariant, including noniconic polyester soil release polymer Texcare® SRN100, SRN170, SRN170 C, SRN170 SG Terra, SRN172, SRN240, SRN260, SRN260 life, SRN260 SG Terra, SRN UL50, SRN300, SRN325. One of the most preferred commercial polymer is Texcare SRN300. Examples of suitable polyester soil release polymer also include REPEL-O-TEX® line of polymers supplied by Rhodia/Solvay/Syensqo, including nonionic polyester soil release polymer REPEL-O-TEX® Crystal, Crystal PLUS, Crystal NAT, SRP6. Other examples of commercial polyester soil release polymers also include WeylClean® series of soil release polymers supplied by WeylChem, currently Catexcel, including noniconic polyester soil release polymer WeylClean® PLN1, PLN2.

Suitable polyesters can also be anionic polyester, such as those disclosed in US20230406999, WO2024032573, WO2024032573, WO2024094800, WO2024094785, WO2024094790, WO2024094802, WO2024094803, WO2024094800.

The raw materials for the preparation of polyesters can be based on fossil carbon or renewable carbon. Renewable carbon includes carbon originating from biomass, carbon capture, or chemical recycling. Preferably, the raw materials for the preparation of the polyester soil release polymers of the invention are at least partly based on renewable carbon. The Renewable Carbon Index (RCI, a measure of sustainability by dividing the number of carbons derived from renewable sources by the total number of carbons in an active ingredient) of the polyester soil release polymer is above 40%, more preferably above 50%, even more preferably above 60%, particularly preferably from 70 to 100% (including 100%), and most preferably 100%.

### Other Ingredients

The detergent particles according to the present disclosure may comprises other ingredients selected from the group consisting of other surfactants, other polymers, perfume, perfume encapsulates, surfactants, enzymes, brighteners, bleach, bleach activators, phosphates, zeolite, silicates, carbonates, sodium chloride, and any combinations thereof.

The detergent particles according to the present disclosure may further comprises other ingredients. For example, the detergent particle further comprises from 0.01% to 5%, preferably from 0.1% to 4%, more preferably from 0.5% to 3%, by weight of the detergent particle, of sodium sulfosuccinate. The addition of sodium sulfosuccinate helps to stabilize the high active LAS-containing detergent particles.

The other ingredients may be incorporated into the detergent particles during or after the process of making the detergent particle. For example, the other ingredients may be sprayed onto the surface of the detergent particle according to the present disclosure. Alternatively, the other ingredient may be introduced as an ingredient into the slurry used to make the detergent particle, and further convert to a detergent particle according to the present disclosure.

### Cleaning Composition Containing Detergent Particle

The present invention is also related to a cleaning composition containing the detergent particles described herein. The cleaning composition comprises from 0.1% to 99%, preferably from 5% to 90%, by weight of the composition, of the detergent particle.

The cleaning composition is a laundry detergent composition in a solid form. Suitable laundry detergent compositions in solid form include any detergent composition comprising ingredient in solid form. The cleaning composition in solid form can be in the form of an agglomerate, granule, flake, extrudate, bar, tablet, powder, bead, sheet, fibrous article, and single or multi-compartment water-soluble unit dose detergent.

When the cleaning composition in solid form is a multi-compartment water-soluble unit dose detergent, at least one of the compartments comprises detergent particles according to this invention. Preferably, the single or multi-compartment water-soluble unit dose detergent comprises polyvinyl alcohol. More Preferably, the composition is partially enclosed, or completely enclosed, by a film such as a polyvinyl alcohol film.

The cleaning composition may also be in the form of an insoluble substrate, for example a non-woven sheet, impregnated with detergent actives.

The solid composition can be made by methods such as dry-mixing, agglomerating, compaction, spray drying, pan-granulation, spheronization or any combination thereof. The solid composition typically has a bulk density of from 300 g/l to 1,500 g/l, typically from 500 g/l to 1,000 g/l.

Preferably, the cleaning composition in solid form, comprising:
from 0.1% to 99%, preferably from 5% to 90%, by weight of the composition, of the detergent particle the detergent particle according to any one of claims 1 to 14, and
from 0.1% to 99%, by weight of the composition, of an additional ingredient, wherein the additional ingredient is selected from the group consisting of perfume, perfume encapsulates, surfactants, polymers, enzymes, bleach, bleach activators, phosphates, zeolite, silicates, carbonates, sodium chloride, chelants, hueing agents, dye transfer inhibitors, and any combinations thereof.

The cleaning composition may be capable of cleaning and/or softening fabric during a laundering process. Typically, the composition is formulated for use in an automatic washing machine or for hand-washing use, and preferably for hand-wash.

### Methods of Using the Cleaning Composition

The compositions are typically used for cleaning and/or treating a situs inter alia a surface or fabric. As used herein, “surface” may include such surfaces such as dishes, glasses, and other cooking surfaces, hard surfaces, hair or skin. Such method includes the steps of contacting an embodiment of the laundry detergent or cleaning composition, in neat form or diluted in a wash liquor, with at least a portion of a surface or fabric, then optionally rinsing such surface or fabric. The surface or fabric may be subjected to a washing step prior to the aforementioned rinsing step. For purposes of the present invention, “washing” includes but is not limited to, scrubbing, wiping, and mechanical agitation.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

As will be appreciated by one skilled in the art, the laundry detergent of the present invention is ideally suited for use in laundry applications. Accordingly, the present invention includes a method for laundering fabric. The method may comprise the steps of contacting a fabric to be laundered with a laundry detergent comprising the carboxyl group-containing polymer. The fabric may comprise most of any fabric capable of being laundered in normal consumer use conditions. The solution preferably has a pH of from about 8 to about 10.5. The laundry detergent may be employed at concentrations of from about 500 ppm to about 15,000 ppm in solution, and optionally, more dilute wash conditions can be used. The water temperatures typically range from about 5° C. to about 90° C. The water to fabric ratio is typically from about 1:1 to about 30:1.

The method of laundering fabric may be carried out in a top-loading or front-loading automatic washing machine or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. For dilute wash conditions, the wash liquor may comprise 150 litres or less of water, 100 litres or less of water, 60 litres or less of water, or 50 litres or less of water, especially for hand washing conditions, and can depend on the number of rinses.

Typically, from 0.01 Kg to 2 Kg of fabric per litre of wash liquor is dosed into the wash liquor. Typically, from 0.01 Kg, or from 0.05 Kg, or from 0.07 Kg, or from 0.10 Kg, or from 0.15 Kg, or from 0.20 Kg, or from 0.25 Kg fabric per litre of wash liquor is dosed into the wash liquor.

Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor.

### Test Method

### 1. Ring Shear Test

The flowability (ff_{c}) of each sample detergent granule is the ratio of σ₁ (consolidation stress) to σ_{c} (unconfined yield strength), which is used to characterize flowability numerically: the larger ff_{c} means the better a bulk solid flow. The flowability (ff_{c}) data is generated from a Schulze Ring Shear Tester RST-XS, while the detailed test procedure of the ring shear tester is described in detail in ASTM standard D-6773.

The specific operating condition of the Schulze Ring Shear Tester RST-XS are described hereinafter. To run a flow-ability test, firstly fill sufficient pre-conditioned detergent granules into the shear cell and form a flat powder bed by scraping off the excess material with a spatula. The mass of the filled bottom ring is then weighed and recorded. Set the filled bottom ring on the ring shear tester and place the lid concentrically to the bottom ring on the bulk solid specimen. For preshear the bottom ring is rotated clockwise (seen from the top), whereby the lid is prevented from rotation by the tie rods. The consolidation stress at pre-shear is set as 16000 Pa, and five different other consolidation stresses (3200 Pa, 6400 Pa, 8000 Pa, 9600 Pa and 12800 Pa) are also applied during the same test. The minimum shear stress required to shear the bulk sample (shear to failure) at each consolidation stress is then measured to generate a yield locus (see FIG. 4.10 in D. Schulze, Powder and Bulk Solid: Behavior, Characterization, Storage and Flow, Springer, 2008). The yield locus is then used to calculate the consolidation stress, σ1 and the unconfined yield strength, σ_{c}; and the ratio of σ₁ to σ_{c} is the flowability, ff_{c}. The larger ffc is, i.e., the smaller the ratio of the unconfined yield strength, σ_{c}, to the consolidation stress, σ₁, the better a bulk solid flows. Similar to the classification used by Jenike, one can define flow behavior as follows:
ff_{c}<1 not flowing
1<ff_{c}<2 very cohesive
2<ff_{c}<4 cohesive
4<ff_{c}<10 easy flowing
10<ff_{c}, free flowing

### 2. Moisture Analysis

2.0 grams of a powder sample is tested in the Mettler Toledo HR73 Halogen Moisture analyzer at 110deg C. for 30 minutes. The percentage of lost mass at the end of the measurement is recorded as the sample's moisture content. Ensure the moisture is below 1.0%.

### EXAMPLES

The detergent particles of the present invention can be made by the following exemplary process:

In the initial step, all the necessary ingredients for the surfactant formulation are blended to create a uniform surfactant slurry. The slurry undergoes a precisely controlled drying process to eliminate moisture and attain the desired dried produce with defined moisture target. Subsequently, the particles are carefully sieved to achieve defined particle size distribution (PSD, see 1.1 for details). This meticulous process ensures that the resulting particles are optimized for the intended flowability test, enabling effective comparisons and evaluations.

### Example 1: Sample Preparation

### 1.1 Making Sample

A) In the 60 L emulsification tank, with the jacket temperature set at 60° C., combine the following ingredients: 4.40 kg of deionized water, 4.01 kg of 50% NaOH solution, and 0.72 kg of sodium sulfosuccinate. Add 15.55 kg of linear C10-16 alkyl benzene sulfonic acids (LAS) and 1.46 kg of deionized water. Additionally, introduce 3.67 kg of a non-surfactant salt solution, such as 18.2% sodium sulfate solution. Finally, incorporate one or more polymers into the mixture.
B) drying the Step A slurry to a solid material containing from about 0.5% to 3% by weight of water;
C) surfactant-containing solid formed in Step C to milling and sieving to get particles within defined particle distribution.
   1.2 Prepare Sample with Matched PSD
1. Prepare the RoTap Sieve Shaker apparatus by ensuring it is clean and in proper working condition.
2. Select the appropriate set of sieves with desired mesh sizes for the particle size range of interest (1180 um, 850 um, 600 um, 425 um, 150 um, and pan).
3. Weigh around 100 g sample to be analyzed, ensuring it is representative and properly homogenized.
4. Place the sample onto the top sieve of the RoTap stack.
5. Securely attach the sieve stack onto the RoTap and start the sieving process.
6. Set 5 min of sieving time.
7. After the sieving process is complete, carefully remove the sieves from the RoTap stack.
8. Collect the material retained on each sieve, ensuring to brush off any particles adhering to the sieve surfaces.
9. Weigh the material retained on each sieve to match the size as below distribution:

| Sieve | 1180 | 850 | 600 | 425 | 150 | 0 |
|---|---|---|---|---|---|---|
| PSD | 1% | 30% | 32% | 22% | 15% | 0% |

### Example 2: Exemplary Compositions of Detergent Particles

Exemplary formulations for particles described herein are set forth in Table 1. Components for which multiple suitable materials are listed, all permutations of possible formulations are contemplated herein.

TABLE 1
Comparative and inventive Examples of
the detergent particle formulations

| Ingredients | Comparative | Inventive |
|---|---|---|
| (weight % of active) | Example A | Example B |
| NaLAS | 90% | 82% |
| Soil Release Polymer* | 0% | 8% |
| Trisodium Sulfosuccinate | 2% | 2% |
| Sulfate | 5% | 5% |
| Water | 1% | 1% |
| Minors | balance | balance |

*Texcare SRN300 (CAS: 152442-40-5) commercially available from Clariant

### Example 3: Flowability—Ring Shear Test

The Flowability of the Comparative and Inventive Examples are tested according to the Ring Shear Test described in Test Method hereinabove. The Results are listed in Table 2 below.

TABLE 2
flowability data (under 16 kPa)

| | Comparative | Inventive |
|---|---|---|
| | Example A | Example B |
| Flowability (ff_{c}) | 4.1 | 8.9 |
| Δff_{c} | — | 4.8 |

The results show clearly that the detergent particle containing combination of the LAS and soil release polymer exhibits improved flowability vs. the detergent particle containing LAS only.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent particle comprising:
from 50% to 95%, by weight of the detergent particle, an alkyl benzene sulphonate anionic surfactant; and
from 0.1% to 20%, by weight of the detergent particle, a polyester soil release polymer;
wherein the polyester soil release polymer comprises:
(a) at least one terephthalate structural unit,
(b) at least one alkylene glycol structural unit, and
(c) at least one polyalkylene glycol structural unit comprising at least one ethylene glycol moiety.

2. The detergent particle according to claim 1, wherein the alkyl benzene sulphonate anionic surfactant comprises a C₁₀-C₂₀ linear alkyl benzene sulphonate.

3. The detergent particle according to claim 1, wherein the linear alkyl benzene sulphonate anionic surfactant is present in an amount of from 60% to 95% by weight of the detergent particle.

4. The detergent particle according to claim 1, wherein the polyester soil release polymer comprises at least one terephthalate structural unit (a), at least one alkylene glycol structural unit (b), at least one polyalkylene glycol structural unit selected from a first polyalkylene glycol structural unit (c1) and/or a second polyalkylene glycol structural unit (c2), with the structures of (a), (b), (c1) and (c2) as shown below: 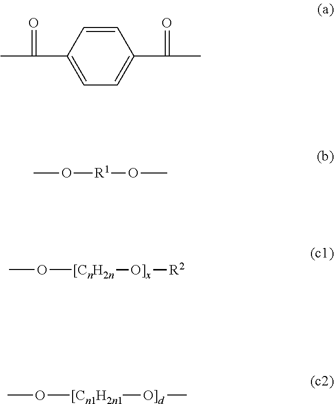
wherein,
R¹ is a linear or branched alkylene group represented by the formula (CₘH₂ₘ) wherein m is an integer from 2 to 12,
R² is a linear or branched C₁-C₃₀ alkyl group, a cycloalkyl group with from 5 to 9 carbon atoms or a C₆-C₃₀ arylalkyl group,
n is independently selected from an integer from 2 to 12,
x is, based on a molar average, a number from 2 to 200,
n1 is independently selected from an integer from 2 to 12,
d is, based on molar average, a number from 2 to 200,
wherein the polyalkylene glycol structural units (c1) and/or (c2) comprises at least one ethylene glycol moiety,
wherein the PEG content of the polyester soil release polymer is from 40% to 90%.

5. The detergent particle according to claim 4, wherein the molar ratio between (i) ethylene glycol moiety present in the polyalkylene glycol structural unit (c) to (ii) terephthalate moiety present in the terephthalate structural unit (a) ranges from 8 to 25.

6. The detergent particle according to claim 4, wherein the alkylene glycol structural unit (b) has a structure such that,
R¹ is a linear or branched alkylene group represented by the formula (CₘH₂ₘ) wherein m is each independent an integer of from 2 or 3.

7. The detergent particle according to claim 4, wherein the first polyalkylene glycol structural unit (c1) has a structure such that,
R² is a linear or branched C₁-C₆ alkyl group,
n is independently selected from an integer from 2 to 4,
x is, based on a molar average, a number from 4 to 150.

8. The detergent particle according to claim 4, wherein the second polyalkylene glycol structural unit (c2) has a structure such that,
n1 is independently selected from an integer of from 2 to 4,
d is, based on a molar average, a number of from 4 to 150.

9. The detergent particle according to claim 4, wherein the second polyalkylene glycol structural unit (c2) has a structure: 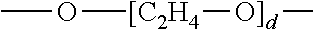
wherein d is, based on a molar average, a number of from 10 to 120.

10. The detergent particle according to claim 4, wherein the average total molecular weight of ethylene glycol moiety present in the polyalkylene glycol structural units (c1) and (c2) in the polyester soil release polymer molecule, is from 1000 to 20000.

11. The detergent particle according to claim 1, further comprising from 0.01% to 5%, by weight of the detergent particle, of sodium sulfosuccinate.

12. The detergent particle according to claim 1, wherein said detergent particle is characterized by: (1) a particle size distribution Dw50 of from 100 μm to 1000 μm; (2) a bulk density of from 400 to 1000 g/L; and (3) a moisture content of from 0 wt % to 3 wt %.

13. The detergent particle according to claim 1, said detergent particle is a solid free-flowing particle.

14. A water-soluble unit dose article, comprising the detergent particle according to claim 1.

15. A cleaning composition in solid form, comprising:
from 0.1% to 99% by weight of the composition, of the detergent particle the detergent particle according to claim 1, and
from 0.1% to 99%, by weight of the composition, of an additional ingredient, wherein the additional ingredient is selected from the group consisting of perfume, perfume encapsulates, surfactants, polymers, enzymes, bleach, bleach activators, phosphates, zeolite, silicates, carbonates, sodium chloride, chelants, hueing agents, dye transfer inhibitors, and any combinations thereof.
